(19) United States
(12) Patent Application Publication
(10) Pub. No.: US 2018/0242591 A1
(43) Pub. Date: Aug. 30, 2018

(54) Insect Repellent

(71) Applicant: Evolva SA, Reinach (CH)

(72) Inventors: Jean Davin Amick, Lexington, KY (US); Deepali Saran, Lexington, KY (US)

(73) Assignee: Evolva SA, Reinach (CH)

(21) Appl. No.: 15/755,988

(22) PCT Filed: Aug. 23, 2016
(86) PCT No.: PCT/EP2016/069912

§ 371 Date: Feb. 27, 2018

Related U.S. Application Data
(60) Provisional application No. 62/212,206, filed on Aug. 31, 2015.
(60) Provisional application No. 62/212,211, filed on Aug. 31, 2015.

(51) Int. Cl. A01N 65/12; A01N 31/04

(52) U.S. Cl. CPC A01N 65/12; A01N 25/06; A01N 2300/00; A01N 31/04

(57) ABSTRACT

Insect repellent and pesticide compositions including a santalene component are disclosed.

### BACKGROUND OF THE INVENTION

### Field of the Invention

This disclosure relates generally to the use of santalene components as insect repellents and/or pesticides. In particular, this disclosure relates to the use of santalene components for repelling and killing insects and pests, such as fleas, mosquitoes, bed bugs, ticks, and/or termites.

### Description of Related Art

Many insects and pests are considered to be pests to humans, domesticated animals, and pets because they often can serve as vectors for disease, can bite or sting, can cause annoyance, can damage property, including causing structural damage to homes or agricultural products, and can result in decreased enjoyment of indoor and outdoor environments. Examples of such insects and pests include fleas, mosquitoes, bed bugs, ticks, and termites.

DEET (N,N-Diethyl-meta-toluamide) is effective for repelling insects and nuisance pests, such as fleas, mosquitoes, bed bugs, ticks, and termites. However, this compound has its disadvantages. For example, DEET is perceived by many to have a strong “chemical” smell at the concentrations usually used in most formulations, but DEET is less effective in low concentrations. In addition to DEET, examples of compounds used to repel or kill insects and pests include synthetic pyrethroids such as permethrin, carbamates, and chlorinated hydrocarbons such as lindane. As well, organic insecticides and inorganic salts are known in the art for their ability to repel or kill insects (e.g., see U.S. Pat. Nos. 2,423,284, 4,308,279, 4,376,784, 4,948,013, 5,434,189 and 6,048,892). Although some of these chemicals can be effective as pesticides, not all are approved for direct or indirect contact with animals, including humans.

Natural pesticides offer an alternative to synthetic pesticides and are considered generally safer for humans and the environment. Examples of natural pest repellents or pesticides include natural or synthetic oils of camphor, cedarwood, citronella, eucalyptus, pennyroyal, and the pyrethrins. Though, such natural pesticides have their disadvantages. For example, plant oils tend to be expensive to isolate in commercial quantities and usually are very volatile, evaporating quickly when applied or exposed to the elements. Also, there are reports that some pests are developing a resistance to certain natural pesticides. For example, it is reported that some bedbugs have developed a resistance to pyrethrins and pyrethroids. Resistance to insecticides in arthropods is widespread, with at least 400 species being resistant to one or more insecticides (U.S. Pat. No. 5,571,901).

In addition, some natural pesticides have unintended effects on animals. For example, application of some pyrethrins can cause skin problems, asthma, headache, nausea, sneezing and/or vomiting (e.g., see U.S. Department of Labor, Chemical Sampling Information—Pyrethrin (2006)).

Thus, new natural compositions that are both safe and effective are needed to kill and/or repel insects and pests.

### SUMMARY OF THE INVENTION

Provided herein are safe and effective natural compositions that kill and/or repel insects and pests.

In a first aspect, the invention provides an insect and pest repellent composition that includes a plurality of santalene components and a carrier. In one embodiment, the carrier comprises an aqueous liquid carrier, water, a gel, a powder, a zeolite, a cellulosic material, a microcapsule, an alcohol such as ethanol, a hydrocarbon, a fat, and/or an oil, and mixtures thereof. In another embodiment, the insect and pest repellent composition further includes an additive. In one embodiment, the additive comprises one or more of a fragrance, a preservative, a propellant, a pH buffering agent, a colorant, a surfactant, an emulsifier, a solvent, and/or a salt, and mixtures thereof. In a further embodiment, the insect and pest repellent composition further includes an additional active ingredient. In one embodiment, the additional active ingredient comprises a synthetic insecticide and/or a natural insecticide or pesticide or repellent. In a particular embodiment, the synthetic insecticide is DEET. In a further particular embodiment, the natural insecticide is a pyrethrin. In one embodiment, the insect and pest repellent composition has an insect and pest repellency of at least about 75%. In a particular embodiment, the composition repels at least one of ticks and fleas. In a further particular embodiment, the composition repels at least one of a mosquito, a bed bug, and a termite. In a further embodiment, the santalene component comprises one or more of α-santalene, β-santalene, epi-β-santalene, α-trans-bergamotene, (Z)-α-santalol, (E)-α-santalol, (Z)-β-santalol, (E)-3-santalol, (E)-epi-β-santalol, (Z)-epi-β-santalol), (Z)-α-trans-bergamotol, (E)-α-trans-bergamotol, and derivatives thereof. In a particular embodiment, the santalene component includes santalol. In another particular embodiment, the plurality comprises less than all of α-santalene, β-santalene, epi-β-santalene, α-trans-bergamotene, (Z)-α-santalol, (E)-α-santalol, (Z)-β-santalol, (E)-β-santalol, (E)-epi-β-santalol, (Z)-epi-β-santalol), (Z)-α-trans-bergamotol, (E)-α-trans-bergamotol, and derivatives thereof.

In a second aspect, the invention provides an insect repellent composition that includes at least about 2% santalol, and an aqueous carrier. Advantageously, the insect repellent composition is formulated for topical administration. In one embodiment, the insect repellent composition is formulated as an aerosol, a solution, an emulsion, an oil, a lotion, a soap, a shampoo, a conditioner, a spray, a gel, a cosmetic, a perfume, or a cologne.

In a third aspect, the invention provides an insect repellent composition that includes about 0.01 to 75% santalol, 0 to about 30% of an additional active ingredient, about 25 to about 99.9% carrier, and 0 to about 50% of an additive. In one embodiment, the composition includes at least about 5% to about 40% santalol. In another embodiment, the composition includes greater than about 1% to about 30% of an additional active ingredient.

In a fourth aspect, the invention provides a method of repelling an insect or pest from a surface that includes providing an insect repellent composition comprising one or more synthetic santalene components and applying an amount of the insect repellent composition to a surface to repel an insect or pest therefrom. In one embodiment, the surface is an exterior surface of an individual. In a particular embodiment, the exterior surface is skin or hair. In a particular embodiment, the skin is a specialized type of skin comprising mucous membrane or scalp. In a further embodiment, the surface is an exterior surface that is the fur, hair, skin, or hide of a domesticated animal or pet. In another embodiment, the surface is a hard surface. In a particular embodiment, the hard surface is a structural surface. In a further particular embodiment, the structural surface is untreated lumber, treated lumber, a wood beam, a wood board, cardboard, particle board, a joist, a stud, a baseboard, wood trim, a hardwood floor, a window sill, a porch floor, a deck, a door, a wall, a ceiling, interior furniture, or exterior furniture. In another embodiment, the surface is a soft surface. In a particular embodiment, the soft surface is a carpet, a curtain, a rug, padded furniture, a cushion, a mattress, a box spring, a mattress cover, a bedbug repellent mattress pad, a bed sheet, a blanket, a pillow, a doll, or a stuffed animal. In another embodiment, the insect repellent composition is formulated as an aerosol, a solution, an emulsion, an oil, a lotion, a soap, a shampoo, a conditioner, a spray, a gel, a cosmetic, a perfume, or a cologne. In another embodiment, the insect repellent composition is formulated as a bracelet, a necklace, an article of clothing to be worn by an individual, a pet collar, or other item to be worn by an animal.

In a fifth aspect, the invention provides a method of repelling an insect or pest from an animal that includes providing an animal feed comprising one or more synthetic santalene components and feeding the animal feed to an animal.

In a sixth aspect, the invention provides a pesticide composition that includes a plurality of synthetic santalene components and a carrier. The composition is capable of killing at least one of fleas and ticks.

In a seventh aspect, the invention provides a method of repelling an insect or pest from a surface including providing a composition comprising about 2% santalol and a carrier, applying an amount of the composition to a surface to repel an insect or pest therefrom, and repelling the insect or pest from the surface. The surface is a soft surface, a hard surface, or the exterior surface of an animal, and the insect or pest is a mosquito, a bed bug, a flea, a tick, or a termite.

These and other features and advantages of the present invention will be more fully understood from the following detailed description of the invention taken together with the accompanying claims. It is noted that the scope of the claims is defined by the recitations therein and not by the specific discussion of features and advantages set forth in the present description.

### DESCRIPTION OF DRAWINGS

FIG. 1A-1B. FIG. 1A depicts the pathway by which santalene synthase catalyzes the formation of santalenes and bergamotene, which can subsequently undergo oxidation to their respective alcohols. FIG. 1B depicts the chemical structure of the produced santalenes and bergamotene and their corresponding alcohols, including stereoisomers thereof, including α-santalene (1), β-santalene (2), epi-β-santalene (3), α-exo-bergamotene (4), (Z)-α-santalol (5), (E)-α-santalol (6), (Z)-β-santalol (7), (E)-β-santalol (8), (E)-epi-β-santalol (9), (Z)-epi-β-santalol (10), (Z)-α-exo-bergamotol (11), and (E)-α-exo-bergamotol (12).

FIG. 2. Peak annotated gas chromatography-flame ionization detection (GC-FID) chromatogram for synthetic santalol showing nine constituents. GC-FID analysis was conducted on an Agilent 7890B GC-FID fitted with a ZB-WaxPlus (Phenomenex, Polyethylene Glycol, 30 m×0.25 mm×0.25 um) high polarity column. The GC-FID used an oven temperature programmed between 40-250° C., starting at 40° C. for 3 min, with ramp of 10° C./min to 130° C., 2° C./min to 200° C., finally a ramp of 45° C./min to 250° C. with a final hold at 250° C. for 15 min, using H₂ carrier gas—at 2.67 mL/min, with injections of 1 uL, split 1:10. One microliter of synthetic santalol was dissolved in 1 ml of ethyl acetate in a GC vial and injected on GC-FID for analysis. Peak No. 1=(Z)-α-santalol (percent area under the curve (AUC %)=32); Peak No. 2=(Z)-α-exo-bergamotol (AUC %=7); Peak No. 3=unknown (AUC %=4); Peak No. 4=(E)-α-santalol (AUC %=9); Peak No. 5=(E)-α-exo-bergamotol (AUC %=1); Peak No. 6=(Z)-epi-β-santalol (AUC %=6); Peak No. 7=(Z)-β-santalol (AUC %=31); Peak No. 8=(E)-epi-β-santalol (AUC %=1); and Peak No. 9=(E)-β-santalol (AUC %=8). Total Z AUC %=76. Total E AUC %=19.5. Z/E AUC ratio=3.9.

FIG. 3. Number of Aedes aegypti mosquito probes received over a twenty minute period by wells treated with various formulations. 2% and 5% formulations include 2% and 5%, respectively, santalol in ethanol.

FIG. 4. Calculated repellency for formulations exposed to Aedes aegypti mosquitoes over a twenty minute period. 2% and 5% formulations include 2% and 5%, respectively, santalol in ethanol.

### DETAILED DESCRIPTION

All publications, patents and patent applications cited herein are hereby expressly incorporated by reference in their entirety for all purposes.

Before describing the present invention in detail, a number of terms will be defined. As used herein, the singular forms “a,” “an,” and “the” include plural referents unless the context clearly dictates otherwise. For example, reference to “an active ingredient” means one or more active ingredients.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that can or cannot be utilized in a particular embodiment of the present invention.

For the purposes of describing and defining the present invention it is noted that the term “substantially” is utilized herein to represent the inherent degree of uncertainty that can be attributed to any quantitative comparison, value, measurement, or other representation. The term “substantially” is also utilized herein to represent the degree by which a quantitative representation can vary from a stated reference without resulting in a change in the basic function of the subject matter at issue.

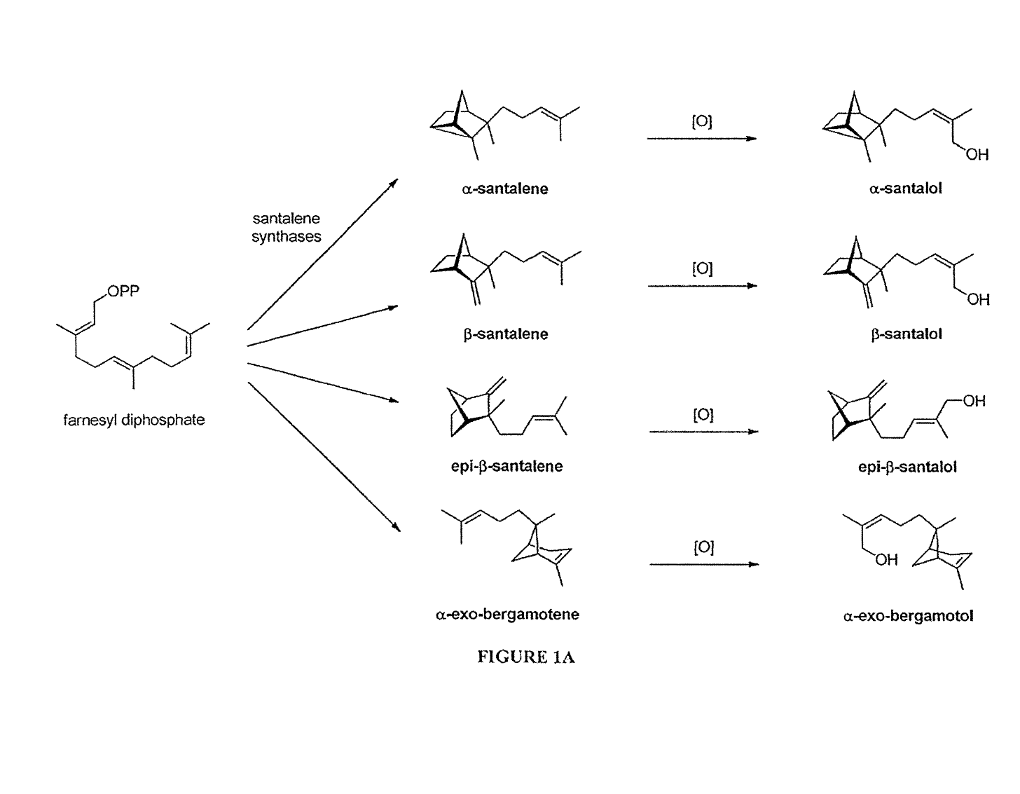

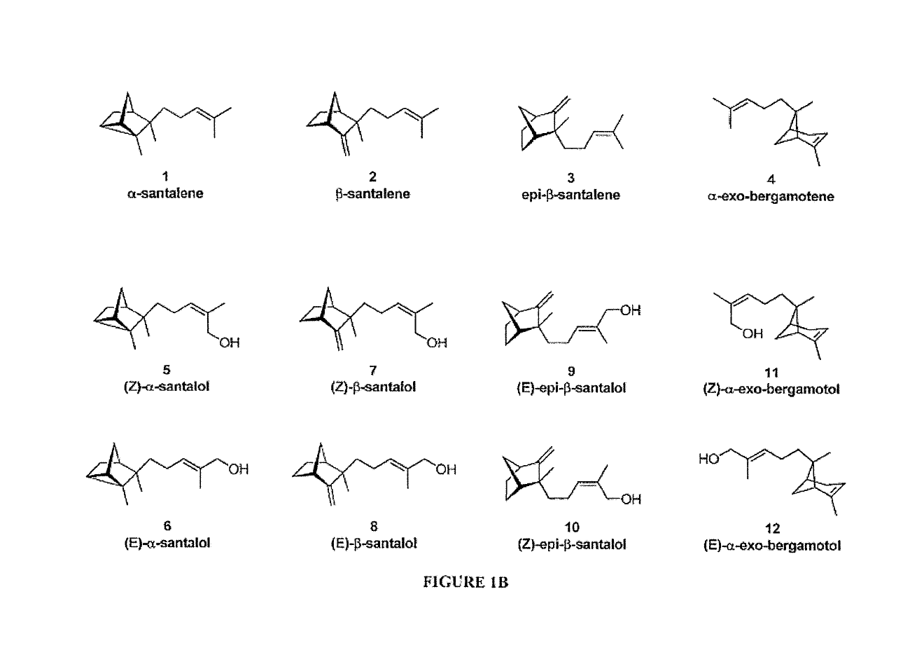

As used herein, the term “santalene component” refers to one or more of the sesquiterpene compounds shown in FIGS. 1A and 1B that were purified and/or isolated from chemical oxidation of a mixture of products produced in a host modified to express enzymes of the santalol biosynthetic pathway, and derivatives and analogs thereof. For example, the one or more santalene components contemplated for use herein may be produced in vivo through expression of one or more enzymes involved in the santalol biosynthetic pathway in a recombinant yeast, such as those described in U.S. Ser. No. 14/673,720, the disclosure therein being expressly incorporated by reference herein.

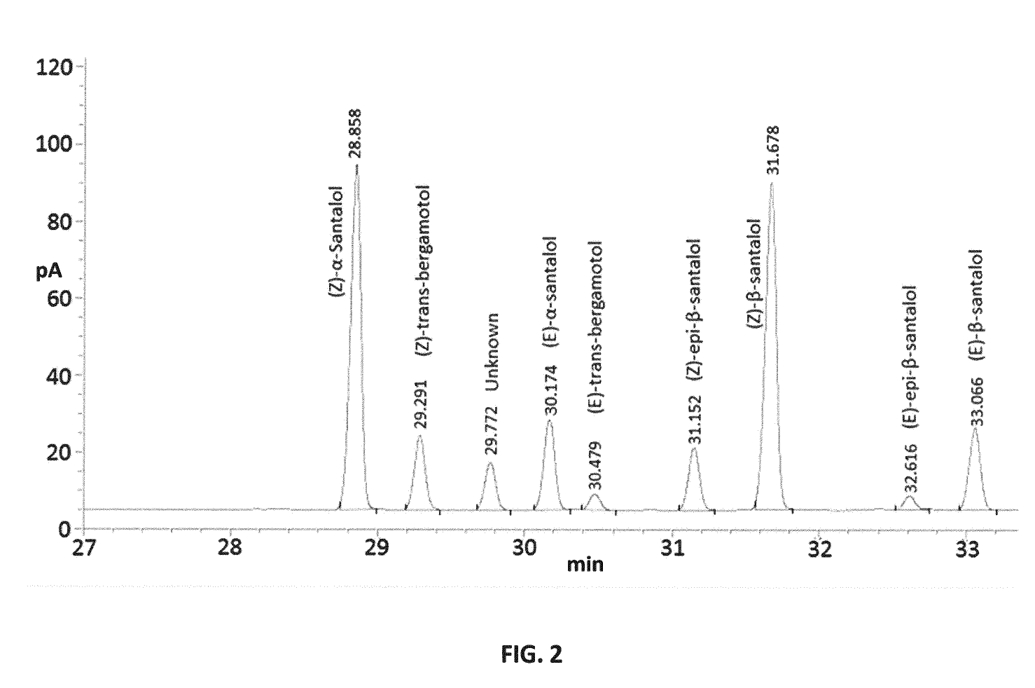

As used herein, the term “santalol” refers to a mixture of natural or synthetic santalene components that can include up to 9 synthetic santalene components as separated by gas chromatography-flame ionization detection (GC-FID) as shown in FIG. 2 and produced using the biosynthetic pathway disclosed in U.S. Ser. No. 14/673,720. These components include the (E)- and (Z)-isomers of α-santalol, β-santalol, epi-β-santalol, and α-exo-bergamotol, plus an additional sesquiterpene alcohol that represents less than 5% of the total material by GC AUC %.

As used herein, the term “active ingredient” refers to a chemical compound or mixture of chemical compounds that kills and/or repels an insect or a pest.

As used herein, the term “insect” refers to animals of the class Insecta.

As used herein, the term “pest” refers to insects and other invertebrates that cause irritation and/or damage to animals or plants and animal- and plant-derived materials, or that carry disease.

As used herein, the term “individual” refers to a human.

As used herein, the term “insect repellent” refers to a chemical compound or formulation that repels and/or kills insects and pests.

As used herein, the term “about” refers to ±10% of a given value.

As used herein, the terms “or” and “and/or” are utilized to describe multiple components in combination or exclusive of one another. For example, “x, y, and/or z” can refer to “x” alone, “y” alone, “z” alone, “x, y, and z,” “(x and y) or z,” “x or (y and z),” or “x or y or z.”

Sandalwood (Santalum album) is a slow-growing hemi-parasitic tropical tree of great economic value found growing in southern India, Sri Lanka, eastern Indonesia and northern Australia. Sandalwood heartwood has a unique fragrance imparted by resins and essential oils, including santalols, santalenes and other sesquiterpenoids, in the heartwood. In general, Santalum album heartwood contains up to 6% dry weight sesquiterpene oils. Sandalwood oil predominantly contains Z isomers of the sesquiterpene alcohols α-santalol, β-santalol, Z-α-trans-bergamotol and epi-β-santalol, and additionally includes E-isomers of the same sesquiterpene alcohols, α-santalene, santalene, α-bergamotene, epi-β-santalene, β-bisabolene, α-curcumene, β-curcumene and γ-curcumene. Sandalwood oil has a soft, sweet-woody and animal-balsamic odor that is imparted from the terpenoid β-santalol and is highly valued.

Sandalwood oil may be obtained by distillation of the heartwood and has been used as a perfume ingredient, in incenses and traditional medicine and in pesticides. However, sandalwood trees require decades to be replenished and have become an endangered species, at least in India, due to their overuse. In addition, the chemical makeup of sandalwood oil may vary from tree to tree and within specific trees over time, thus sandalwood trees are not an ideal source for reliable and consistent supplies of santalol. Moreover, sandalwood trees are susceptible to disease, which may render santalol production unpredictable. Therefore, a source of santalol that would provide reliable, sustainable, more consistent, and scalable production is desirable. Chemical approaches to purify or otherwise generate santalols have been attempted; however, these approaches suffer from considerable inefficiencies and expense.

Recently, modified santalene synthases have been identified and expressed in host cells to catalyze production of santalenes and other compounds, see U.S. Ser. No. 14/673,720. This system represents a new, reliable avenue for large scale production of synthetic santalol with greater production capacity, sustainability, and chemical consistency compared to using sandalwood trees.

Here, synthetic santalol is shown to be an effective active ingredient in insect and pest repellent formulations. Moreover, based on the results presented herein, synthetic santalene components can be effective as insect repellents, insecticides, and pesticides by themselves and may contribute cumulatively to other santalene components and/or additional active ingredients with respect to insect repellency and/or pesticidal effect.

In particular, compositions disclosed herein are effective for repelling and killing ticks, mosquitoes, bed bugs, termites, and/or fleas and are believed to be effective for killing and repelling other pests and insects from the same or similar genera.

The compositions for killing or repelling insects and/or pests provided herein can contain a carrier and at least about 0.1%, or at least about 1%, or at least about 2%, or at least about 5%, or at least about 7.5%, or at least about 10%, or greater than about 10%, or greater than about 15%, or greater than about 20%, or greater than about 25%, or greater than about 50% by weight a santalene component or santalol. In some applications, a santalene component or santalol can be present in an amount that is greater than about 60%, about 70%, about 80%, about 90%, about 95%, or about 99% by weight of the composition. In one example, the provided compositions contain a santalene component or santalol in an amount at or about 0.01% to at or about 75% by weight of the composition. In another example, a composition may contain a santalene component or santalol in an amount of from at or about 1% to at or about 50% by weight of the composition. In another example, a composition may contain a santalene component or santalol in an amount of from at or about 5% to at or about 40% by weight of the composition. In another example, a composition may contain a santalene component or santalol in an amount of from at or about 10% to at or about 30% by weight of the composition. In another example, a composition may contain a santalene component or santalol in an amount of from at or about 15% to at or about 25% by weight of the composition. In another example, a composition may contain a santalene component or santalol in an amount of from at or about 1% to at or about 90% by weight of the composition. In another example, a composition may contain a santalene component or santalol in an amount of about 10%, or about 15%, or about 20%, or about 25%, or about 30%, or about 50% by weight of the composition. In another example, a composition may contain a santalene component or santalol or a combination thereof in an amount of up to 99% by weight of the composition.

In another embodiment, a contemplated formulation may be seen in Table No.

TABLE NO. 1
Contemplated formulation

| Ingredient | Approximate Wt. % |
|---|---|
| A synthetic santalene component or santalol | 0.01-75 |
| Additional active Ingredients | 0-30 |
| Carriers | 25-99.9 |
| Additives | 0-50 |

In certain embodiments, compositions contemplated herein may include a synthetic santalene component or a synthetic santalol and one or more additional active ingredients, such as DEET, a pyrethroid, or any other synthetic or natural insecticide or pesticide or repellent, and any mixture thereof. An additional active ingredient may be added to a composition in an amount of greater than about 1% to about 30%, or about 5%, or about 10%, or about 15%, or about 20%, or about 25%, or about 30%, or about 50% by weight of the composition.

In other embodiments, compositions contemplated herein may include a synthetic santalene component or santalol in combination with one or more additives, such as a fragrance, a preservative, a propellant, a pH buffering agent, a colorant, a surfactant, an emulsifier, a solvent, a salt, and the like. An additive may be added to a composition in an amount of greater than about 1% to about 50%, or about 5%, or about 10%, or about 15%, or about 20%, or about 25%, or about 30%, or about 50% by weight of the composition.

In other embodiments, compositions may include a carrier, such as an aqueous liquid carrier, water, a gel, a powder, a zeolite, a cellulosic material, a microcapsule, an alcohol such as ethanol, a hydrocarbon, a polymer, a wax, a fat, and/or an oil, and the like. A carrier may be added to a composition in an amount of about 10%, or about 15%, or about 20%, or about 25%, or about 30%, or about 50% by weight of the composition. In some applications, a carrier can be present in an amount that is at or greater than about 60%, about 70%, about 80%, about 90%, about 95%, or about 99% by weight of the composition.

In certain embodiments, a composition may be formulated for application topically on an exterior surface of an individual, for example, to the skin or hair. For example, the composition may be provided as an aerosol, a solution, an emulsion, an oil, a lotion, a soap, a shampoo, a conditioner, a spray, a gel, a cosmetic, a perfume, or a cologne.

In further embodiments, a composition may be formulated for application onto an exterior surface of an animal, such the fur, hair, skin, hide, etc. of a domesticated animal or pet.

In other embodiments, a composition may be formulated for ingestion by an animal to convey insect or pest repellency through secretion of an active ingredient onto the skin, hair, fur, and the like. For example, the composition may be formulated as animal feed, such as an extruded animal food, a grain, a canned food, an animal treat, a dog bone, and the like.

In other embodiments, a composition may be formulated for application to a hard surface, such as a structural surface, including but not limited to untreated lumber, treated lumber, a wood beam, a wood board, cardboard, particle board, joist, stud and the like, a baseboard, wood trim, a hardwood floor, a window sill, a porch floor, a deck, a door, a wall, a ceiling, interior furniture, exterior furniture, and the like. Similarly, a composition may be formulated for application to a soft surface, such as a carpet, a curtain, a rug, padded furniture, a cushion, a mattress, a box spring, a mattress cover, a bedbug repellent mattress pad, a bed sheet, a blanket, a pillow, a doll, a stuffed animal, and the like.

In further embodiments, a composition contemplated herein may be sprayed, sprinkled, poured, or brushed onto a surface. In accordance, the composition may be formulated as a spray, a powder, a paint, a stain, a wax, a gel, a paste, or in any other form.

In further embodiments, a composition contemplated herein may be impregnated within a passive insect repellent dispenser and/or charged within a reservoir of an active insect repellent dispenser either of which may be wearable by an individual or placeable in an interior or exterior volume. For example, the composition may be formulated as a bracelet, a necklace, or an article of clothing to be worn by an individual. Further, the composition may be formulated as a pet collar or other item to be worn by an animal. Further, the composition may be formulated as a blanket, a netting, an insect or pest trap, such as or similar to fly paper, a glue trap, and the like.

In another embodiment, a device including an attractant may be used to carry a contemplated composition. For example, the device may include an insect or pest food and/or a pheromone and/or a scent and/or a lure and/or may emit light and/or sound including subsonic emissions, and the like.

The invention will be further described in the following examples, which do not limit the scope of the invention described in the claims.

### EXAMPLES

The Examples that follow are illustrative of specific embodiments of the invention, and various uses thereof. They are set forth for explanatory purposes only and are not taken as limiting the invention.

### Example No. 1: An In Vitro Laboratory Bioassay to Determine the Efficacy of a Compound as a Repellent Against Bed Bugs

### Summary

An in vitro laboratory trial was conducted to assess the preliminary repelling action of a compound applied to filter paper against bed bugs in a choice test design. Bed bugs were placed in an arena with treated filter paper in one half and untreated in the other. After 24 hours, their locations within the arena were recorded. Calculations of repellency were based on comparison to an entirely untreated arena.

Santalol at 2% and 5% concentrations provided 99.9% and 100% repellency to bed bugs, respectively. Santalol was highly effective at repelling bed bugs in this forced-choice assay.

### Methodology

Test System

Adult, mixed sex bed bugs (Cimex lectularius) were obtained from the Schal Lab at NCSU in Raleigh, N.C. Bed bugs were fed 3-7 days prior to the start of the test.

Test Treatments and Application

Santalol was diluted in ethanol to 2% and 5% concentrations. The treatments were applied to filter paper at a rate of 1 ml per 9 cm diameter filter paper circle. Therefore, each treated filter paper received 0.5 mL of product.

Test Container Preparation

Petri dishes (9 cm) were modified to serve as the test containers for testing. A circular hole was cut in the bottom of a clean petri plate. Fine mesh nylon cloth was then fastened to the bottom using adhesive, covering the hole. The petri plate was then inverted, with the screened bottom serving as the top.

Treated and untreated filter papers were cut in half and fitted into the new bottom of the test containers. Treated replicates received one half treated and one half untreated filter paper. Untreated replicates received entirely untreated filter paper.

Experimental Design

Ten bed bugs were placed in the center of each test container and covered with the fine-mesh lid. The containers were then kept in darkness at ambient laboratory conditions (24° C.±3° C. (75° F.±5° F.); 45% relative humidity ±10%) for 24 hours. At the end of the exposure period, the distribution (bed bugs on or under each filter paper) of bed bugs was recorded. Red light, gloves and a dust mask were used to reduce detection by the bed bugs and to minimize disturbance by the observer.

Data Analysis

The number of bed bugs in each location was converted to a percentage, for which the average and standard deviation were calculated across all five replicates. Percent repellency was calculated with the following formula:

% repellency=(100−((t/T)/(c/C)))*100

Where t=number of insects on treated side of treated arena
T=total number of insects in treated arena
c=average number of insects on left side of untreated arenas
C=average total number of insects in untreated arenas

### Results

Assessment results are summarized in Table No. 2 below. Santalol at 2% and 5% concentrations provided 99.9% and 100% repellency to bed bugs, respectively. Santalol was highly effective at repelling bed bugs in this forced-choice assay.

TABLE NO. 2
Location of bed bugs, and calculated percent repellency
(average ± standard error, n = 5) of a treatment
against bed bugs (Cimex lectularius)
Ethanol control

| | | |
|---|---|---|
| Means | Standard Error | Percent |

| Left | Right | Left | Right | repellency |
|---|---|---|---|---|
| 68.0% | 32.0% | 10.7% | 10.7% | n/a |

| | | |
|---|---|---|
| Means | Standand Error | Percent |

| | | | | |
|---|---|---|---|---|
| Untreated | Treated | Untreated | Treated | repellency |

Santalol 2% in Ethanol

| | | | | |
|---|---|---|---|---|
| 96.0% | 4.0% | 4.0% | 4.0% | 99.9 ± 0.1% |

Santalol 5% in Ethanol

| | | | | |
|---|---|---|---|---|
| 100.0% | 0.0% | 0.0% | 0.0% | 100.0 ± 0.0% |

### Example No. 2: Evaluation of the Repellency of a Compound Against Mosquitoes Using an In Vitro Method

### Summary

A laboratory trial was conducted to evaluate the repellency of santalol against female Aedes aegypti mosquitoes using an in vitro method. A 20% DEET positive control and untreated and ethanol negative controls were also assessed for comparison purposes.

Test substances were applied to prepared collagen membranes placed over heated, blood-filled wells and exposed to mosquitoes. The number of mosquitoes probing each well was recorded at two minute intervals up to 20 minutes.

### Methodology

Test System

Female adult laboratory reared Aedes aegypti mosquitoes (susceptible) were obtained from Benzon Research in Carlisle, Pa. 250 mosquitoes were used per replicate (5 replicates per test). Adult mosquitoes were 3-8 days old.

Test Treatments and Application

Santalol was diluted in ethanol to 2% and 5% concentrations.

A positive control consisting of 20% DEET in ethanol was prepared using stock solutions. Negative controls consisted of no treatment, and ethanol-only treatment.

The treatments were applied directly to prepared collagen membranes by pipetting 25 μL of the appropriate substance onto a membrane and spreading it evenly with the tip of the pipette.

Experimental Design

Exposure Container.

A 30.5 cm×30.5 cm×30.5 cm rigid plastic frame supported by four, 4 cm high legs, with a sleeved entry on one side and a sliding door on the bottom.

Membrane Feeder.

Five wells (3 cm in diameter×8 mm in depth) in line on a hollow plastic block (6 cm wide×22 cm long×3 cm deep), which fits through the sliding door in the bottom of the exposure container. Hoses attached to each side of the block circulate heated water that is pumped from a water bath. The sliding door in the bottom of the exposure container covers and uncovers the wells in the membrane feeder, allowing mosquitoes to access the wells.

Test Set-Up.

The membrane feeder was connected to a heated water bath, and warm water passed through the feeder via a circulating pump so that the wells were warmed to 89-95° F. Seventy-two (72) mg of ATP (disodium salt) were added to 26 mL of warmed citrated bovine blood, which was poured into the wells until they were completely full.

The collagen membranes (3 cm in diameter) were briefly dipped in tap water and blotted with a paper towel, then placed over each of the wells (using vacuum grease as an adhesive), completely covering the blood. The membranes were then treated as described above and left for five minutes to dry.

Exposure to Mosquitoes.

The mosquitoes were introduced into the exposure container just prior to exposure to the membranes. The exposure container was then placed on the membrane feeder and the sliding door opened, allowing the mosquitoes to access the wells. The number of mosquitoes probing each membrane was recorded every two minutes for twenty minutes.

The above procedures were repeated until five replicates were completed. A new batch of 250 female mosquitoes and fresh blood were used for each replicate, and the wells were cleaned in between replicates. The position of the treatments was rotated for each replicate, so that each treatment was tested on each of the five wells.

Statistical Analyses

Percent repellency was calculated for each replicate using the total number of probes with the following formula:

$$\% repellency = \frac{C - T}{C} \times 100$$

$$Where \\ C = the total number of probes on the untreated well$$

$$T = the total number of probes on the treated well$$

Average percent repellency and standard error (SE) were calculated across all five replicates. Shapiro-Wilks tests were conducted to determine the normality of the data, based on total number of probes per replicate. Student t-tests (with concurrent F-tests for variance) were used to determine significance between the 2% and 5% formulations compared to 20% DEET.

### Results

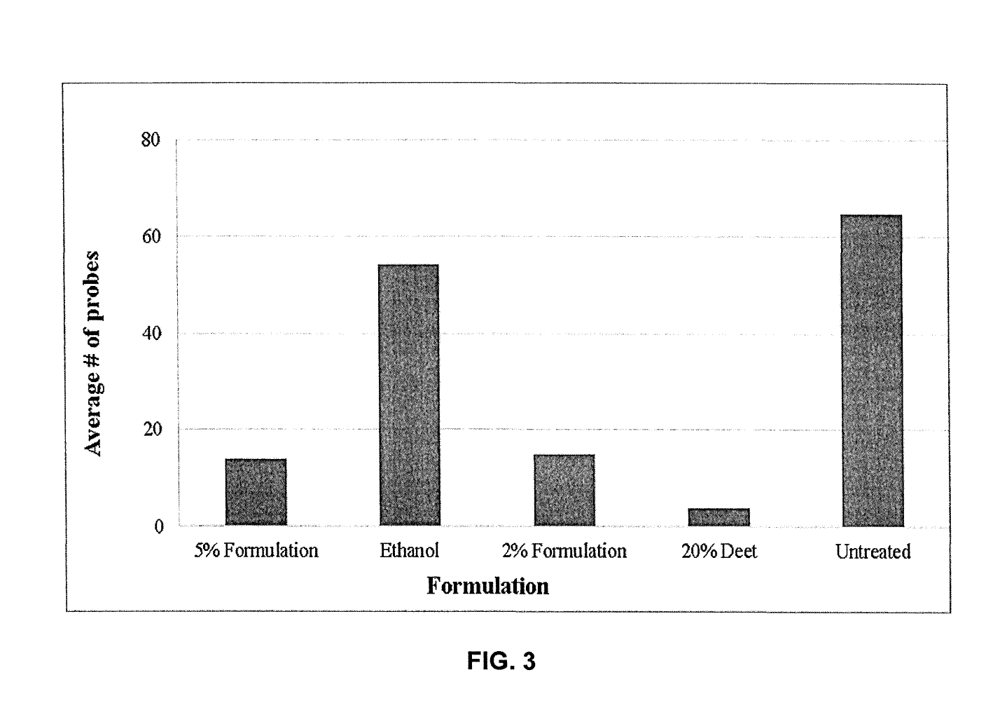

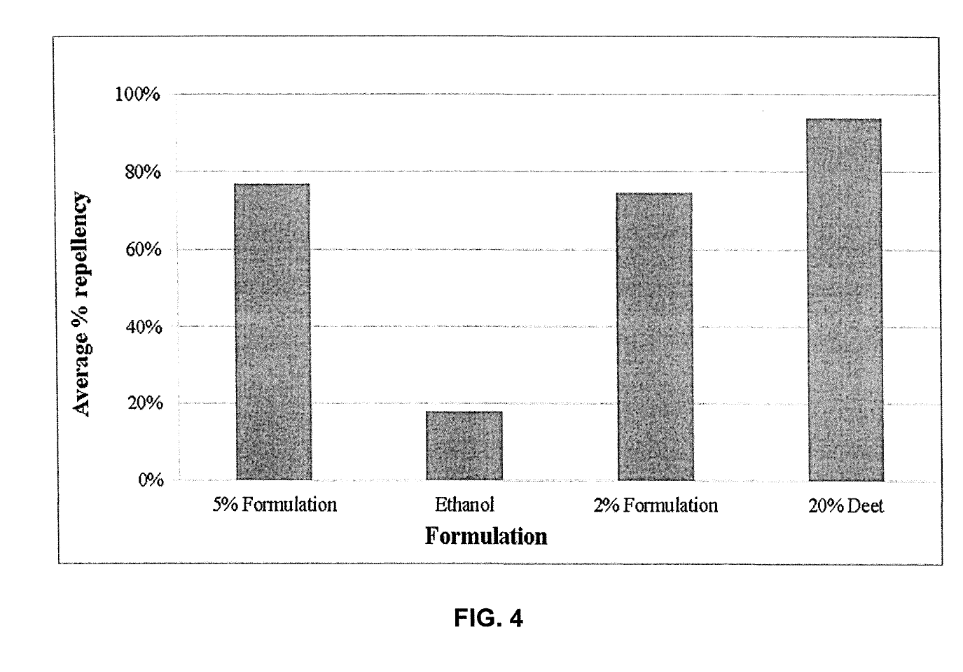

Results are summarized in Table No. 3 below and FIGS. 3 and 4. Santalol demonstrated similar repellency at both 2% and 5% concentrations (74.6% and 77%, respectively), but its repellency was lower than that of 20% DEET (93.9%).

TABLE NO. 3
Summary of results for in-vitro assay of repellency

| Formulation | Average percent repellency ± SE |
|---|---|
| Ethanol | 17.6 ± 9.2 |
| 2% Conc. | 74.6 ± 3.8 |
| 5% Conc. | 77.0 ± 6.5 |
| 20% DEET | 93.9 ± 2.3 |

The data show that santalol is an effective repellent against Aedes aegypti mosquitoes. Though at concentrations of 2% and 5% santalol was less effective than 20% DEET, the data suggest that higher concentrations of santalol may be more effective. Moreover, the data indicate that significant repellency compared to ethanol alone is achieved with only 2% santalol. Therefore, these data support the premise that adding even small amounts of santalol to insect repellent compositions containing conventional synthetic and/or natural insect repellents and/or pesticides may allow for reduced amounts of those other active ingredients to be used in the compositions while still maintaining (or even improving) effective repellency.

### Example No. 3: An In Vitro Laboratory Bioassay to Determine the Efficacy of a Compound Against Eastern Subterranean Termites, in Terms of Repellency

### Summary

An in vitro laboratory trial was conducted to assess the preliminary repelling action of santalol applied to filter paper against eastern subterranean termites in a choice test design.

Termites were placed in arenas with treated filter paper in one half and untreated in the other. After 24 hours, their locations within the arena were recorded. Calculations of repellency were based on comparison to an entirely untreated arena.

Santalol at 2% and 5% concentrations provided 100% and 87.5% repellency to termites, respectively. Santalol was highly effective at repelling termites in this forced-choice assay.

### Methodology

Test System

Eastern subterranean termites (Reticulitermes flavipes) were collected from field sites in Maryland. Only worker termites were used in the test.

Test Treatments and Application

Santalol was diluted in ethanol to 2% and 5% concentrations.

The treatments were applied to filter paper at a rate of 1 mL for a 9 cm filter paper disc (456 μL per cut strip).

Test Container Preparation

One long glass tube with screened ends (to provide ventilation) was used for each test container. Test containers were placed into a larger container to prevent escape and were kept in darkness and at high humidity for the duration of the experiment.

Treated and untreated filter papers were cut into strips and fitted inside the glass tubes. Treated replicates received one treated and one untreated filter paper (marked on both sides to differentiate treated from untreated). The two paper strips were pushed end to end to form one continuous strip. The strip did not completely cover the inner diameter of the tube, but a 2 mm gap was left running the entire length of the tube for viewing termite activity. Untreated replicates received ethanol treated filter paper.

Experimental Design

Ten termites were placed in the center of each test container. The containers were then kept in darkness and at high humidity conditions for 24 hours. At the end of the exposure period, the distribution (on or under each filter paper) of termites was recorded.

Data Analysis

The number of termites in each location was converted to a percentage, for which the average and standard deviation were calculated across all three replicates.

Percent repellency was calculated with the following formula:

% repellency=(100−((t/T)/(c/C)))*100

Where t=number of insects on treated side of treated arena
T=total number of insects in treated arena
c=average number of insects on right side of untreated arenas
C=average total number of insects in untreated arenas

### Results

Assessment results are summarized in Table No. 4 below. Santalol at 2% and 5% concentrations provided 100% and 87.5% repellency to termites, respectively. It is important to note that the termites remaining on the treated side in the 5% treatment were dead. Though it is not known if the treatment was lethal to the termites, their lack of movement did have an effect on the repellency assay and suggests that santalol may be an effective pesticide for certain insects. Overall, santalol was highly effective at repelling termites in this forced-choice assay.

TABLE NO. 4
Location of termites, and calculated percent repellency
(average ± standard error, n = 3) of a treatment
against termites (Reticulitermes flavipes).
Ethanol control

| | | |
|---|---|---|
| Means | Standard Error | Percent |

| Left | Right | Left | Right | repellency |
|---|---|---|---|---|
| 46.7 | 53.3 | 13.3 | 13.3 | n/a |

| | | |
|---|---|---|
| Means | Standard Error | Percent |

| | | | | |
|---|---|---|---|---|
| Untreated | Treated | Untreated | Treated | repellency |

Santalol 2% in Ethanol

| | | | | |
|---|---|---|---|---|
| 100.0 | 0.0 | 0.0 | 0.0 | 100.0 ± 0.0 |

Santalol 5% in Ethanol

| | | | | |
|---|---|---|---|---|
| 93.3 | 6.7 | 6.7 | 6.7 | 87.5 ± 12.5 |

### Example No. 4 An In Vitro Laboratory Bioassay to Determine the Efficacy of a Compound Against Eastern Subterranean Termites, in Terms of Mortality

### Summary

An in vitro laboratory trial was conducted to assess the preliminary killing action of santalol applied to filter paper against eastern subterranean termites.

Termites were introduced to glass tube arenas containing filter paper that had been treated with one of two concentrations of the compound. An ethanol control group was also assessed for comparison purposes. Termites were monitored daily until reaching 100% mortality (48 hours).

Termites treated with santalol did not experience high mortality at 24 hours (23-26.7%); however, by 48 hours the treatment produced 100% mortality at both concentrations. It can be concluded that santalol is an effective pesticide for at least certain insects.

### Methodology

Test System

Eastern subterranean termites (Reticulitermes flavipes) were collected from field sites in Maryland. Only worker termites were used in the experiments.

Test Treatments and Application

Santalol was diluted in ethanol to 2% and 5% concentrations.

The treatments were applied to filter paper at a rate 1 mL per 9 cm filter paper disc (456 μL per cut strip). Ethanol-treated filter papers were used for the negative control group.

Experimental Design

The treated (or solvent, for controls) filter papers were cut into strips and curled to insert inside glass tubes with screened ends. The filter paper did not cover the entire surface of the tube; a 2 mm gap was left to view termite activity.

Termites were then introduced to test containers. Assessments were conducted daily until termites reached 100% mortality. Visibly affected termites were scored as either moribund or dead at each assessment.

Statistical Analyses

The number of termites in each assessment category was totaled and the percentages calculated. The average percent and standard error (SE) in each category were calculated across all three replicates. No further statistical analysis was deemed necessary.

### Results

Assessment results are summarized in Table No. 5 below. Termites treated with santalol did not experience high mortality at 24 hours (23-26.7%); however, by 48 hours the treatment produced 100% mortality at both concentrations. It can be concluded that santalol was successful at producing mortality in eastern subterranean termites, and that santalol is an effective pesticide for at least some insects at low concentrations.

TABLE NO. 5
Effects on eastern subterranean termites (Reticulitermes flavipes) when
treated with two concentrations of santalol (means ± SE, n = 3).

| Time post | Means | | | Standard Error | | |
|---|---|---|---|---|---|---|
| intro- | Mori- | | Affected | Mori- | | Affected |
| duction | bund | Dead | (M + D) | bund | Dead | (M + D) |

Ethanol control

| | | | | | | |
|---|---|---|---|---|---|---|
| 24 hours | 0.0% | 0.0% | 0.0% | 0.0% | 0.0% | 0.0% |
| 48 hours | 0.0% | 0.0% | 0.0% | 0.0% | 0.0% | 0.0% |

Santalol 2% in Ethanol

| | | | | | | |
|---|---|---|---|---|---|---|
| 24 hours | 40.0% | 23.3% | 63.3% | 10.0% | 8.8% | 18.6% |
| 48 hours | 0.0% | 100.0% | 100.0% | 0.0% | 0.0% | 0.0% |

Santalol 5% in Ethanol

| | | | | | | |
|---|---|---|---|---|---|---|
| 24 hours | 50.0% | 26.7% | 76.7% | 25.2% | 14.5% | 12.0% |
| 48 hours | 0.0% | 100.0% | 100.0% | 0.0% | 0.0% | 0.0% |

### Example No. 5 An In Vitro Evaluation of Santalol Against Bed Bugs and Mosquitoes, in Terms of Knockdown and Mortality

### Summary

A laboratory trial was conducted to assess the efficacy of santalol applied to filter paper against bed bugs (Cimex lectularius) and mosquitoes (Aedes aegypti), in terms of knockdown and mortality. Two concentrations (2% and 5% in ethanol) of santalol were assessed. A negative control group, consisting of substrates treated with ethanol, was also assessed for comparison purposes.

Test systems were introduced to treated filter paper, and were monitored at intervals up to 72 hours.

Santalol at 2% concentration produced 66% mortality in mosquitoes during the experimental duration. At 5% concentration, the formulation produced 100% mortality in mosquitoes by 24 hours. Santalol produced less than 7% mortality in bed bugs at both tested concentrations.

Therefore, the data indicate that santalol is effective as a pesticide against mosquitoes.

### Methodology

Test System

The arthropods indicated in Table No. 6 below were obtained from the indicated sources for testing:

TABLE NO. 6
Arthropods used for testing.

| Name | Scientific name | Source |
|---|---|---|
| Bed bugs, Harlan | Cimex lectularius | Schal Lab, NCSU, Raleigh, NC |
| Strain | | |
| Yellow fever | Aedes aegypti | Benzon Research, Carlise, PA |
| mosquitoes | | |

All tested arthropods were mixed-sex adults.

Test Treatments and Application

Santalol was diluted in ethanol to 2% and 5% concentrations. The treatments were applied to filter paper at a rate 1 mL per 9 cm filter paper disc. Ethanol-treated filter papers were used for the negative control group.

Experimental Design

Treated filter papers were cut so that it covered the bottom of a suitable container for each test system:

Bed Bugs—

Petri dish bottom 3.54 inches (9 cm) in diameter was inverted and served as the substrate for a 2.75 inch (7 cm) treated filter paper circle. A smaller Petri dish bottom 2.16 inches (5.5 cm) in diameter with a 0.5 inch (1.27 cm) hole burned in the center with the sides painted with Fluon served as the treatment container. The small Petri dish bottom was inverted and placed over the treated filter paper. Bed bugs were introduced into the treated surface through the hole in the dish bottom and the hole covered with a plastic disc. The entire treatment chamber was held together with 2 rubber bands.

Yellow Fever Mosquitoes—

Inverted 10 ounce (295 ml) clear plastic cups with a 0.5 inch (1.27 cm) hole burned into the center of the bottom and with the sides coated with Fluon were used at the treatment containers. The bottoms of the containers consist of Petri dish lids 3.54 inches (90 cm) in diameter lined with a treated filter paper circle the same diameter. The cup was placed over the filter paper in the lid and both were secured in place using 2 rubber bands. A plastic disc was placed over the opening to prevent escapes after mosquitoes were introduced into the containers.

After the arthropods were introduced into the test arenas, assessments were conducted at 30 minutes, and 1, 4, 24, 48, and 72 hours post-introduction. Visibly affected arthropods were scored as either knocked down or dead at each assessment.

Statistical Analyses

The number of arthropods in each assessment category was totaled and the percentages calculated. The average percent and standard error in each category was then calculated across all five replicates. No further statistical analysis was deemed necessary.

### Results

Assessment results are summarized in Tables Nos. 7 and 8 below. Santalol at 2% concentration produced 60% mortality in mosquitoes during the experimental duration. At 5% concentration, the formulation produced 100% mortality in mosquitoes by 24 hours. Santalol produced less than 7% mortality in bed bugs at both tested concentrations.

TABLE NO. 7
Effect on bed bugs (Cimex lectularius) when treated with two
concentrations of santalol (means ± standard errors, n = 5).

| | Means | | | Standard Error | | |
|---|---|---|---|---|---|---|
| Time post | Knock- | | Affected | Knock- | | Affected |
| introduction | down | Dead | (K + D) | down | Dead | (K + D) |

Ethanol control

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 0.0% | 0.0% | 0.0% | 0.0% | 0.0% | 0.0% |
| 24 hours | 0.0% | 4.0% | 4.0% | 0.0% | 2.4% | 2.4% |
| 48 hours | 0.0% | 6.0% | 6.0% | 0.0% | 2.4% | 2.4% |
| 72 hours | 0.0% | 6.0% | 6.0% | 0.0% | 2.4% | 2.4% |

Santalol 2%

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 0.0% | 0.0% | 0.0% | 0.0% | 0.0% | 0.0% |
| 24 hours | 0.0% | 2.0% | 2.0% | 0.0% | 2.0% | 2.0% |
| 48 hours | 0.0% | 2.0% | 2.0% | 0.0% | 2.0% | 2.0% |
| 72 hours | 0.0% | 6.0% | 6.0% | 0.0% | 2.4% | 2.4% |

Santalol 5%

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 0.0% | 0.0% | 0.0% | 0.0% | 0.0% | 0.0% |
| 24 hours | 0.0% | 2.0% | 2.0% | 0.0% | 2.0% | 2.0% |
| 48 hours | 0.0% | 2.0% | 2.0% | 0.0% | 2.0% | 2.0% |
| 72 hours | 0.0% | 4.0% | 4.0% | 0.0% | 2.4% | 2.4% |

TABLE 8
Effect on mosquitoes (Aedes aegypti) when treated with two
concentrations of santalol (means ± standard errors, n = 5). Note that
readings were terminated after 48 hours due to high control mortality.

| | Means | | | Standard Error | | |
|---|---|---|---|---|---|---|
| Time post | Knock- | | Affected | Knock- | | Affected |
| introduction | down | Dead | (K + D) | down | Dead | (K + D) |

Ethanol control

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 0.0% | 0.0% | 0.0% | 0.0% | 0.0% | 0.0% |
| 24 hours | 0.0% | 0.0% | 0.0% | 0.0% | 0.0% | 0.0% |
| 48 hours | 0.0% | 38.0% | 38.0% | 0.0% | 8.0% | 8.0% |

Santalol 2%

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 16.0% | 0.0% | 16.0% | 5.1% | 0.0% | 5.1% |
| 24 hours | 10.0% | 14.0% | 24.0% | 3.2% | 5.1% | 2.4% |
| 48 hours | 12.0% | 60.0% | 72.0% | 5.8% | 6.3% | 5.8% |

Santalol 5%

| | | | | | | |
|---|---|---|---|---|---|---|
| 30 minutes | 0.0% | 0.0% | 0.0% | 0.0% | 0.0% | 0.0% |
| 1 hour | 22.4% | 0.0% | 26.7% | 3.7% | 0.0% | 3.7% |
| 4 hours | 100.0% | 0.0% | 100.0% | 0.0% | 0.0% | 0.0% |
| 24 hours | 0.0% | 100.0% | 100.0% | 0.0% | 0.0% | 0.0% |
| 48 hours | 0.0% | 100.0% | 100.0% | 0.0% | 0.0% | 0.0% |

Therefore, these data indicate that santalol is effective as a pesticide against mosquitoes.

### Example No. 6: In Vitro Evaluation of a Compound as a Repellent Against Cat Fleas and Deer Ticks, Via Choice Tests

### Summary

An in vitro laboratory trial was conducted to assess the preliminary repelling action of one compound applied to filter paper against cat fleas (Ctenocephalides felis) and deer ticks (Ixodes scapularis) in a choice test design.

Fleas were placed in glass cylinders with floors that were half treated and half untreated, and their positions were recorded after 24 hours. Ticks were placed on the untreated half of a petri dish and were monitored for crossing into the treated area. Repellency was calculated by comparison to an entirely untreated control arena.

Results are summarized in Table No. 9 below. Santalol at 2% and 5% concentrations provided 92% repellency to deer ticks, and 68.4-75.6% repellency towards cat fleas. It can be concluded that santalol was very effective at repelling deer ticks and showed potential as a repellent toward cat fleas at the tested concentrations.

TABLE NO. 9
Calculated percent repellency for cat fleas and deer
ticks exposed to santalol at two concentrations.

| | 2% | 5% |
|---|---|---|
| Cat fleas | 68.4 ± 14.7 | 75.6 ± 8.8 |
| Deer ticks | 92.0 ± 4.9 | 92.0 ± 4.9 |

### Methodology

Test System

The following test systems were obtained from the listed sources for this trial:

| Species | Common name | Sex/age | Source |
|---|---|---|---|
| Ctenocephalides | Cat flea | Adult/mixed | EI Labs, |
| felis | | sex | Soquel, CA |
| Ixodes | Deer tick | Adult/mixed | OSU Tick Lab, |
| scapularis | | sex | Stillwater, OK |

Test Treatments and Application

Santalol was diluted in ethanol to 2% and 5% concentrations. The treatments were applied to filter paper at a rate of 1 mL for a 9 cm filter paper disc, and a rate of 1.9 mL for a 15 cm filter paper disc. A negative control group, consisting of untreated filter paper, was also assessed for comparison purposes.

Experimental Design

Cat Fleas

Filter paper was cut so that it covered the bottom of a 15 cm glass cylinder. These circles of filter paper were then cut in half and placed in the cylinder, lining half of the container. Untreated filter paper pieces were placed inside the arenas beside the treated half disc of filter paper so the base of the cylinder was completely covered. This provided an arena with the choice of untreated substrate or treated substrate. Control arenas were lined with two untreated pieces of filter paper. A heating pad was placed under the treated halves of the cylinders to entice fleas to the treated side.

Once the arenas were prepared, ten fleas per replicate were placed onto the untreated side of the test arenas. Distribution of fleas was recorded at 1, 4, and 24 hours.

Deer Ticks

Filter paper was cut so that it covered the bottom of a 9 cm petri dish. These circles of filter paper were then cut in half and placed in the petri dish, lining half of the container. Untreated filter paper pieces were placed inside the arenas beside the treated half disc of filter paper so the base of the petri dish was completely covered. This provided an arena with the choice of untreated substrate or treated substrate. Control arenas were lined with two untreated pieces of filter paper. The petri dish arenas were then placed on their sides, with the control halves positioned at the lower half and the treated half at the upper half.

Ticks were first introduced, one at a time, to the bottom half of the control arena, and monitored to see how long it took to get to the upper “treated” side of the arena. Ticks were allowed up to 3 minutes to cross into the upper area of each arena. Any tick not crossing into the designated treated area was discarded. Once a tick crossed into the upper side of the control arena, it was then gently picked up with forceps and placed in the bottom half of the treated arena, and the procedure repeated. Ticks were considered not repelled if they crossed onto the treated side of the treated arena.

Data Analysis

Fleas

The number of fleas in each location was converted to a percentage, for which the average and standard error were calculated across all five replicates.

Percent repellency was calculated with the following formula:

% repellency=(100−((t/T)/(c/C)))*100

Where t=number of insects on treated side of treated arena
T=total number of insects in treated arena
c=average number of insects on right side of untreated arenas
C=average total number of insects in untreated arenas

Ticks

The number of repelled ticks for each replicate was added together, and the average and standard error were (SE) calculated across all five replicates. The numbers were divided by the total number of ticks per replicate to obtain the percent repellency.

### Results

Assessment results are summarized in Tables No. 10-12 below. Santalol at 2% and 5% concentrations provided 92% repellency to deer ticks, and 68.4-75.6% repellency towards cat fleas. It can be concluded that santalol was very effective at repelling deer ticks and showed potential as a repellent toward cat fleas at the tested concentrations.

TABLE NO. 10
Percent of cat fleas on each half of
test arenas at 24 hours (average ± SE)

| | Left control | Right control |
|---|---|---|
| Untreated | 57.6 ± 4.0 | 42.4 ± 4.0 |
| | Treated left | Untreated right |
| 2% formulation | 17.7 ± 8.1 | 82.3 ± 8.1 |
| 5% formulation | 13.7 ± 4.9 | 86.3 ± 4.9 |

TABLE NO. 11
Percent of deer ticks crossing to treated
half of test arena (average ± SE)

| | |
|---|---|
| Untreated | 100.0 ± 0.0 |
| 2% formulation | 8.0 ± 4.9 |
| 5% formulation | 8.0 ± 4.9 |

TABLE NO. 12
Calculated percent repellency for cat fleas and deer
ticks exposed to santalol at two concentrations.

| | 2% | 5% |
|---|---|---|
| Cat fleas | 68.4 ± 14.7 | 75.6 ± 8.8 |
| Deer ticks | 92.0 ± 4.9 | 92.0 ± 4.9 |

### Example No. 7 An In Vitro Evaluation of Santalol Against Cat Fleas and Deer Ticks, in Terms of Knockdown and Mortality

### Summary

A laboratory trial was conducted to assess the efficacy of santalol applied to filter paper against cat fleas (Ctenocephalides felis) and deer ticks (Ixodes scapularis), in terms of knockdown and mortality. Two concentrations (2% and 5% in ethanol) of santalol were assessed. A negative control group, consisting of substrates treated with ethanol, was also assessed for comparison purposes.

Test systems were introduced to treated filter paper, and were monitored at intervals up to 72 hours.

Santalol at 2% concentration produced 60% and 100% mortality in fleas and ticks, respectively, during the experimental duration. At 5% concentration, the formulation produced 100% mortality in both species by 72 hours

Therefore, the data indicate that santalol is an effective pesticide against cat fleas and deer ticks.

### Methodology

Test System

The arthropods indicated in Table No. 13 below were obtained from the indicated sources for testing:

TABLE NO. 13
Arthropods used for testing.

| Name | Scientific name | Source |
|---|---|---|
| Cat fleas | Ctenocephalides felis | EI Labs, Soquel, CA |
| Deer ticks | Ixodes scapularis | OSU Tick Rearing Lab, |
| | | Stillwater, OK |

All tested arthropods were mixed-sex adults.

Test Treatments and Application

Santalol was diluted in ethanol to 2% and 5% concentrations. The treatments were applied to filter paper at a rate 1 mL per 9 cm filter paper disc. Ethanol-treated filter papers were used for the negative control group.

Experimental Design

Treated filter papers were cut so that it covered the bottom of a suitable container for each test system:

Cat fleas—clear acrylic tubes 6 inches (15.24 cm) in diameter and 12 inches (30.48 cm) high with a tight-fitting circular plastic lid with fine mesh in the center. The bottom of the container was the same used for the lid, but had a solid center. One filter paper circle 5.9 inches (15 cm) in diameter covered the bottom of the container.

Deer ticks—envelopes made from treated 2.5 inch (6.35 cm) filter paper squares served as the containers. After ticks were placed inside envelopes, the openings were clamped shut using small binders.

After the arthropods were introduced into the test arenas, assessments were conducted at 30 minutes, and 1, 4, 24, 48, and 72 hours post-introduction. Visibly affected arthropods were scored as either knocked down or dead at each assessment.

Statistical Analyses

The number of arthropods in each assessment category was totaled and the percentages calculated. The average percent and standard error in each category was then calculated across all five replicates. No further statistical analysis was deemed necessary.

### Results

Assessment results are summarized in Tables Nos. 14 and 15 below. Santalol at 2% concentration produced 60% and 100% mortality in cat fleas and deer ticks, respectively, during the experimental duration. At 5% concentration, the formulation produced 100% mortality in both species by 72 hours.

TABLE NO. 14
Effect on cat fleas (Ctenocephalides felis) when treated with two
concentrations of santalol (means ± standard errors, n = 5).

| | | | | Standard Error | | |
|---|---|---|---|---|---|---|
| | Means | | | | | Affect- |
| Time post | Knock- | | Affected | Knock- | | ed |
| introduction | down | Dead | (K + D) | down | Dead | (K + D) |

Ethanol control

| | | | | | | |
|---|---|---|---|---|---|---|
| 30 minutes | 0.0% | 0.0% | 0.0% | 0.0% | 0.0% | 0.0% |
| 1 hour | 0.0% | 0.0% | 0.0% | 0.0% | 0.0% | 0.0% |
| 4 hours | 0.0% | 0.0% | 0.0% | 0.0% | 0.0% | 0.0% |
| 24 hours | 0.0% | 4.0% | 4.0% | 0.0% | 2.4% | 2.4% |
| 48 hours | 0.0% | 6.0% | 6.0% | 0.0% | 2.4% | 2.4% |
| 72 hours | 0.0% | 8.0% | 8.0% | 0.0% | 2.0% | 2.0% |

Santalol 2%

| | | | | | | |
|---|---|---|---|---|---|---|
| 30 minutes | 2.0% | 0.0% | 3.3% | 2.0% | 0.0% | 2.0% |
| 1 hour | 2.0% | 0.0% | 3.3% | 2.0% | 0.0% | 2.0% |
| 4 hours | 8.0% | 0.0% | 8.0% | 4.9% | 0.0% | 4.9% |
| 24 hours | 30.0% | 28.0% | 58.0% | 7.1% | 5.8% | 10.2% |
| 48 hours | 20.0% | 42.0% | 62.0% | 0.0% | 7.3% | 7.3% |
| 72 hours | 18.0% | 66.0% | 84.0% | 5.8% | 8.7% | 5.1% |

Santalol 5%

| | | | | | | |
|---|---|---|---|---|---|---|
| 30 minutes | 6.0% | 0.0% | 6.7% | 2.4% | 0.0% | 2.4% |
| 1 hour | 6.0% | 0.0% | 6.7% | 2.4% | 0.0% | 2.4% |
| 4 hours | 28.0% | 0.0% | 28.0% | 5.8% | 0.0% | 5.8% |
| 24 hours | 40.0% | 52.0% | 92.0% | 7.1% | 8.6% | 8.0% |
| 48 hours | 20.0% | 68.0% | 88.0% | 7.1% | 11.6% | 7.3% |
| 72 hours | 0.0% | 100.0% | 100.0% | 0.0% | 0.0% | 0.0% |

TABLE NO. 15
Effect on deer ticks (Ixodes scapularis) when treated with two
concentrations of santalol (means ± standard errors, n = 5).

| | Means | | | Standard Error | | |
|---|---|---|---|---|---|---|
| Time post | Knock- | | Affected | Knock- | | Affected |
| introduction | down | Dead | (K + D) | down | Dead | (K + D) |

Ethanol control

| | | | | | | | |
|---|---|---|---|---|---|---|---|
| 30 | minutes | 0.0% | 0.0% | 0.0% | 0.0% | 0.0% | 0.0% |
| 1 | hour | 0.0% | 0.0% | 0.0% | 0.0% | 0.0% | 0.0% |
| 4 | hours | 0.0% | 0.0% | 0.0% | 0.0% | 0.0% | 0.0% |
| 24 | hours | 0.0% | 0.0% | 0.0% | 0.0% | 0.0% | 0.0% |
| 48 | hours | 0.0% | 0.0% | 0.0% | 0.0% | 0.0% | 0.0% |
| 72 | hours | 2.0% | 0.0% | 2.0% | 2.0% | 0.0% | 2.0% |

Santalol 2%

| | | | | | | | |
|---|---|---|---|---|---|---|---|
| 30 | minutes | 0.0% | 0.0% | 0.0% | 0.0% | 0.0% | 0.0% |
| 1 | hour | 0.0% | 0.0% | 0.0% | 0.0% | 0.0% | 0.0% |
| 4 | hours | 50.0% | 0.0% | 50.0% | 9.5% | 0.0% | 9.5% |
| 24 | hours | 56.0% | 44.0% | 100.0% | 16.3% | 16.3% | 0.0% |
| 48 | hours | 8.0% | 92.0% | 100.0% | 3.7% | 3.7% | 0.0% |
| 72 | hours | 0.0% | 100.0% | 100.0% | 0.0% | 0.0% | 0.0% |

Santalol 5%

| | | | | | | | |
|---|---|---|---|---|---|---|---|
| 30 | minutes | 0.0% | 0.0% | 0.0% | 0.0% | 0.0% | 0.0% |
| 1 | hour | 0.0% | 0.0% | 0.0% | 0.0% | 0.0% | 0.0% |
| 4 | hours | 98.0% | 0.0% | 98.0% | 2.0% | 0.0% | 2.0% |
| 24 | hours | 52.0% | 48.0% | 100.0% | 15.0% | 15.0% | 0.0% |
| 48 | hours | 6.0% | 94.0% | 100.0% | 4.0% | 4.0% | 0.0% |
| 72 | hours | 0.0% | 100.0% | 100.0% | 0.0% | 0.0% | 0.0% |

Therefore, the data indicate that santalol is an effective pesticide against cat fleas and deer ticks.

Having described the invention in detail and by reference to specific embodiments thereof, it will be apparent that modifications and variations are possible without departing from the scope of the invention defined in the appended claims. More specifically, although some aspects of the present invention are identified herein as particularly advantageous, it is contemplated that the present invention is not necessarily limited to these particular aspects of the invention. Percentages disclosed herein may otherwise vary in amount by ±10, 20, or 30% from values disclosed herein.

What is claimed is:

1. An insect and pest repellent composition, comprising:
a plurality of santalene components; and
a carrier.

2. The insect and pest repellent composition of claim 1, wherein the carrier comprises an aqueous liquid carrier, water, a gel, a powder, a zeolite, a cellulosic material, a microcapsule, an alcohol such as ethanol, a hydrocarbon, a fat, and/or an oil, and mixtures thereof.

3. The insect and pest repellent composition of claim 1 further comprising an additive.

4. The insect and pest repellent composition of claim 3, wherein the additive comprises one or more of a fragrance, a preservative, a propellant, a pH buffering agent, a colorant, a surfactant, an emulsifier, a solvent, and/or a salt, and mixtures thereof.

5. The insect and pest repellent composition of claim 1 further comprising an additional active ingredient.

6. The insect and pest repellent composition of claim 5, wherein the additional active ingredient comprises a synthetic insecticide and/or a natural insecticide or pesticide or repellent.

7. The insect and pest repellent composition of claim 6, wherein the synthetic insecticide is DEET.

8. The insect and pest repellent composition of claim 6, wherein the natural insecticide comprises a pyrethrin.

9. The insect and pest repellent composition of claim 1, wherein the composition has an insect and pest repellency of at least about 75%.

10. The insect and pest repellent composition of claim 9, wherein the composition repels at least one of ticks and fleas.

11. The insect and pest repellent composition of claim 9, wherein the composition repels at least one of a mosquito, a bed bug, and a termite.

12. The insect and pest repellent composition of claim 1, wherein the santalene component comprises one or more of α-santalene, β-santalene, epi-β-santalene, α-trans-bergamotene, (Z)-α-santalol, (E)-α-santalol, (Z)-β-santalol, (E)-β-santalol, (E)-epi-β-santalol, (Z)-epi-β-santalol), (Z)-α-trans-bergamotol, (E)-α-trans-bergamotol, and derivatives thereof.

13. The insect and pest repellent composition of claim 12, wherein the santalene component comprises santalol.

14. The insect and pest repellent composition of claim 1, wherein the plurality comprises less than all of α-santalene, β-santalene, epi-β-santalene, α-trans-bergamotene, (Z)-α-santalol, (E)-α-santalol, (Z)-β-santalol, (E)-β-santalol, (E)-epi-β-santalol, (Z)-epi-β-santalol), (Z)-α-trans-bergamotol, (E)-α-trans-bergamotol, and derivatives thereof.

15. An insect repellent composition, comprising:
at least about 2% santalol; and
an aqueous carrier,
wherein the insect repellent composition is formulated for topical administration.

16. The insect repellent composition of claim 15, wherein the insect repellent composition is formulated as an aerosol, a solution, an emulsion, an oil, a lotion, a soap, a shampoo, a conditioner, a spray, a gel, a cosmetic, a perfume, or a cologne.

17. An insect repellent composition, comprising:
about 0.01 to 75% santalol;
0 to about 30% additional active ingredient;
about 25 to about 99.9% carrier; and
0 to about 50% additive.

18. The insect repellent composition of claim 18, wherein the composition comprises at least about 5% to about 40% santalol.

19. The insect repellent composition of claim 18, wherein the composition comprises greater than about 1% to about 30% of an additional active ingredient.

20. A method of repelling an insect or a pest from a surface, comprising:
providing an insect repellent composition comprising one or more synthetic santalene components; and
applying an amount of the insect repellent composition to a surface to repel an insect or pest therefrom.

21. The method of claim 20, wherein the surface is an exterior surface of an individual.

22. The method of claim 21, wherein the exterior surface is skin or hair.

23. The method of claim 22, wherein the skin is a specialized type of skin comprising mucous membrane or scalp.

24. The method of claim 20, wherein the surface is an exterior surface that is the fur, hair, skin, or hide of a domesticated animal or pet.

25. The method of claim 20, wherein the surface is a hard surface.

26. The method of claim 25, wherein the hard surface is a structural surface.

27. The method of claim 26, wherein the structural surface is untreated lumber, treated lumber, a wood beam, a wood board, cardboard, particle board, a joist, a stud, a baseboard, wood trim, a hardwood floor, a window sill, a porch floor, a deck, a door, a wall, a ceiling, interior furniture, or exterior furniture.

28. The method of claim 20, wherein the surface is a soft surface.

29. The method of claim 28, wherein the soft surface is a carpet, a curtain, a rug, padded furniture, a cushion, a mattress, a box spring, a mattress cover, a bedbug repellent mattress pad, a bed sheet, a blanket, a pillow, a doll, or a stuffed animal.

30. The method of claim 20, wherein the insect repellent composition is formulated as an aerosol, a solution, an emulsion, an oil, a lotion, a soap, a shampoo, a conditioner, a spray, a gel, a cosmetic, a perfume, or a cologne.

31. The method of claim 20, wherein the insect repellent composition is formulated as a bracelet, a necklace, an article of clothing to be worn by an individual, a pet collar, or other item to be worn by an animal.

32. A pesticide composition, comprising: a plurality of synthetic santalene components and a carrier.

33. A method of repelling an insect or pest from a surface, comprising:
providing a composition comprising about 2% santalol and a carrier;
applying an amount of the composition to a surface to repel an insect or pest therefrom; and
repelling the insect or pest from the surface,
wherein the surface is a soft surface, a hard surface, or the exterior surface of an animal, and
wherein the insect or pest is a mosquito, a bed bug, a flea, a tick, or a termite.
